(19) United States
(12) Patent Application Publication
(10) Pub. No.: US 2022/0319297 A1
(43) Pub. Date: Oct. 6, 2022

(54) Detecting an Obstruction to a Feature of a Building and Warning of the Obstruction

(71) Applicant: UNITED STATES POSTAL SERVICE, Washington, DC (US)

(72) Inventors: Mitchell Obrian MCCULLOUGH, Nashville, TN (US); Yavar MISAGHI BONABI, Portland, OR (US); Ryan J. HRAPSKY, Arlington, VA (US)

(21) Appl. No.: 17/701,218

(22) Filed: Mar. 22, 2022

Related U.S. Application Data
(60) Provisional application No. 63/298,324, filed on Jan. 11, 2022.
(60) Provisional application No. 63/170,242, filed on Apr. 2, 2021.

(51) Int. Cl. G08B 21/18; G08B 3/10

(52) U.S. Cl. CPC G08B 21/18; G08B 3/10

(57) ABSTRACT

A method, an obstruction detecting device, and a non-transitory machine-readable storage medium are provided for detecting an object obstructing access to a feature of a building. A distance sensor connected with an obstruction detecting device emits a signal. The distance sensor receives a reflection of the signal from an object. A microcontroller of the obstruction detecting device, which is connected to the distance sensor, determines a distance from the distance sensor to the object based on an amount of time between the emitting of the signal and the receiving of the reflection of the signal. When the determined distance is less than a threshold distance, indicating that the reflecting object is obstructing access to the feature, the obstruction detecting device provides an alarm.

This application claims the benefit of U.S. Provisional Application No. 63/298,324, filed Jan. 11, 2022, and U.S. Provisional Application No. 63/170,242, filed Apr. 2, 2021. The contents of U.S. Provisional Application No. 63/298,324 and U.S. Provisional Application No. 63/170,242 are hereby incorporated by reference in their entirety.

### FIELD OF THE INVENTION

This invention relates to devices for access to building features, and more particularly, to devices for notifying personnel when access to a feature in a building is obstructed or blocked.

### BACKGROUND

In a commercial building or other structure, the features of the building, such as doorways, stairs, waste disposal areas, utility areas, building equipment (e.g., air conditioners, furnaces, fuse boxes, etc.), and safety features, which may include fire extinguishers, fire alarms, CO detectors, telephones, defibrillators, first aid kits, emergency exits, and the like, often become obstructed or blocked by objects or items, such as rolling carts (e.g., mail carts), office chairs, rolling file cabinets, golf carts, forklifts, boxes, piles of boxes, etc. When access to a feature is blocked, people in the building are unable to access or use the feature, especially during an emergency or in the dark, which can have dire consequences. The risk is higher in a commercial building that is used by an organization or business that employs or handles movable objects or transport devices, such as in a factory floor, workroom or warehouse where items are moved and stored. Examples of such commercial buildings include, but are not limited to, a mail or package processing or sorting center (e.g., operated by the USPS, FedEx, UPS, or the like) that uses wheeled mail carts, mail trays, and the like; a warehouse that uses forklifts, hand trucks, mobile robots, boxes, and the like; a retail store that sells large merchandise (e.g., a home improvement store) and uses carts, wagons, forklifts, and the like; etc.

### SUMMARY

In a first aspect of various embodiments, a method is provided for detecting an object obstructing access to a feature of a building. A signal is emitted via a distance sensor connected with a microcontroller of an obstruction detecting device. A reflection of the signal from an object is received via the sensor. A microcontroller of the obstruction detecting device, which is connected to the distance sensor, determines a distance from the distance sensor to the object that caused the reflection based on an amount of time between the emitting of the signal and the receiving of the reflection of the signal. When the determined distance is less than a threshold distance, a notification device provides an alarm indicating that the reflecting object is the object obstructing access to the feature.

In a second aspect of the various embodiments an obstruction detecting device is provided for detecting an object obstructing access to a feature of a building. The obstruction detecting device includes a microcontroller, a distance sensor connected to the microcontroller, and a notification device connected with the microcontroller. The obstruction detecting device is configured to perform operations. According to the operations, a signal is emitted via the distance sensor. The distance sensor receives a reflection of the signal from an object. The microcontroller determines a distance from the distance sensor to the object that caused the reflection based on an amount of time between the emitting of the signal and the receiving of the reflection of the signal. An alarm is provided via the notification device when the determined distance is less than a threshold distance, indicating that the reflecting object is obstructing access to the feature.

In a third aspect of the various embodiments, a non-transitory machine-readable storage medium is provided that has instructions recorded thereon for configuring a processor to perform operations. According to the operations, a distance sensor connected to the processor emits a signal. A returned reflection of the signal from an object is received by the distance sensor. A distance is determined, by the processor, from the distance sensor to the object that caused the reflection based on an amount of time between the emitting of the signal and the receiving of the reflection of the signal. The processor provides an alarm when the determined distance is less than a threshold distance, indicating that the reflecting object is obstructing access to the feature of the building.

### BRIEF DESCRIPTION OF THE DRAWINGS

FIG. 1 illustrates a first embodiment of an obstruction detecting device.

FIG. 2 shows an obstruction detecting device mounted on a door.

FIG. 3 shows another embodiment of an obstruction detecting device mounted to a post.

FIG. 4 illustrates another embodiment of an obstruction detecting device having an octagonal shape.

FIG. 5 shows another embodiment of obstruction detecting device having a motion detector and a distance sensor.

FIG. 6 illustrates a variation of an obstruction detecting device having solar panels mounted on a top three surfaces.

FIG. 7 is a functional block diagram of an example microcontroller that may be included in the various embodiments of object detecting device.

FIG. 8 is a flowchart of an example process for an obstruction detecting device to determine whether access to a feature is obstructed, according to embodiments.

FIG. 9 is a flowchart of an example process for a microcontroller of an obstruction detecting device to determine whether a signal wire from the obstruction detecting device to a distance sensor is broken or cut, according to embodiments.

FIG. 10 is a flowchart of an example process for timing an inspection interval and triggering an alarm when a time for a safety inspection of a feature of a building has been reached.

FIGS. 11-12 are flowcharts of an example process for an obstruction detecting device to detect an object obstructing access to a feature of a building while preserving battery power, according to an embodiment.

FIG. 13 is a flowchart illustrating an example process for an obstruction detecting device to calibrate a threshold distance to which future calculated distances are compared to determine whether access to a feature of a building is obstructed, according to embodiments.

### DETAILED DESCRIPTION

Reference will now be made in detail to embodiments of the invention, examples of which are illustrated in the accompanying drawings.

Embodiments consistent with the present invention include a method, an obstruction detecting device, and a non-transitory machine-readable medium for detecting an object obstructing access to a feature of the building, for example, a safety feature such as emergency equipment or an emergency exit, and notifying personnel (e.g., by providing an audio and/or visual alarm, transmitting a signal to a computer system or other device, or the like) when access to the feature is blocked or obstructed. Various embodiments also may provide an alarm when the feature (e.g., emergency equipment or other building equipment) is due to be inspected.

Some embodiments may provide an alarm when a wire connecting a sensor to the obstruction detecting device is cut or broken. The providing of the alarm may include sounding an audible alarm and/or illuminating a bright light and/or sending an electronic signal to a remote computer for processing and/or display. In some embodiments the audible alarm may sound one or more beeps and the bright light may flash on and off one or more times. A number of beeps and flashes of the bright light may indicate a cause of the alarm in some embodiments. For example, in some embodiments, a single beep and a single flashing of the light may indicate that access to the feature is obstructed. Two beeps and two blinks of the bright light may indicate time for an inspection of a building feature such as emergency equipment. Three beeps and three blinks of the bright light may indicate a cut or broken wire connecting a sensor to the obstruction detecting device. Other embodiments may use a different number of beeps and flashes to indicate various causes of an alarm.

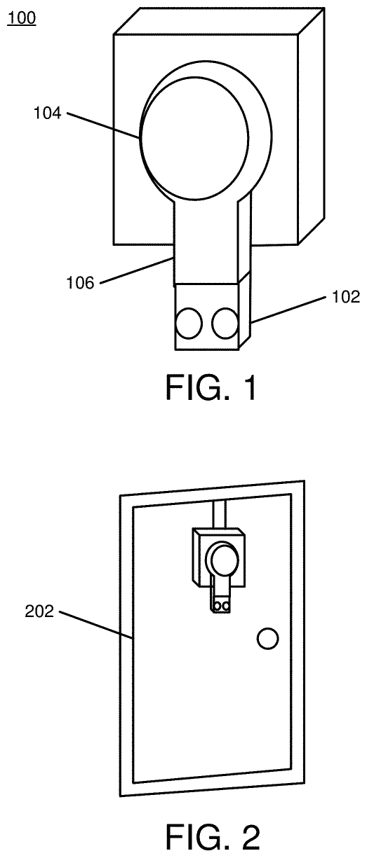

FIG. 1 illustrates a first embodiment of an obstruction detecting device 100 having a distance sensor 102 (e.g., an ultrasonic distance sensor, an infrared distance sensor, or the like), a notification device, such as an audio speaker (not shown), and a bright light 104. In some embodiments, bright light 104 may be a blue light, a red light, an amber light, or another color that may make the bright light more noticeable. Distance sensor 102 may be connected to a microcontroller (not shown) within obstruction detecting device via a pipe or enclosure 106. In some embodiments, the microcontroller may be an Arduino microcontroller. In other embodiments, the microcontroller may be a Raspberry Pi Pico microcontroller, In yet other embodiments, the microcontroller may be any microcontroller that runs MicroPython (or a flavor of C in some embodiments) and that has GPIO pins. Distance sensor 102 may be directed downward and outward to cover an area including a floor in front of the obstruction detecting device 100 and may be able to detect objects such as containers, boxes, carts, chairs, vehicles, people, etc.

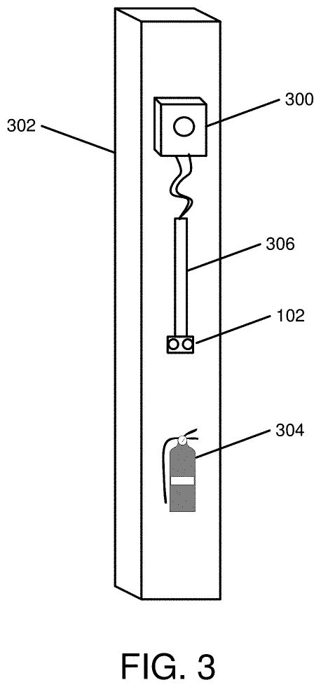

Obstruction detecting device 100 may be mounted on a door 202, as shown in FIG. 2, or another substantially vertical surface such as, for example, a wall. As another example, FIG. 3 shows another embodiment of an obstruction detecting device 300 mounted to a post 302 with a safety feature 304 (e.g., a fire extinguisher) mounted on the post below obstruction detecting device 300. In this embodiment, wires connecting distance sensor 102 to obstruction detecting device 300 may pass through an enclosure such as a pipe or a cable 306 to protect signal wires of distance sensor 102. Distance sensor 102 may be attached to post 302 while connected to obstruction detecting device 300 and may be positioned to detect objects in front of post 302.

Obstruction detecting device 100, 300 may detect an object by causing sensor 102 to emit one or more signal or pulse (e.g., an ultrasonic or infrared signal or pulse), which is reflected off of a reflecting object, such as the floor, as an echo that is received by sensor 102. A distance from sensor 102 to the reflecting object can be calculated based on an amount of time from when the signal or pulse is emitted to when a reflection or echo of the signal or pulse is received by sensor 102. When an obstruction is detected blocking access to the safety feature, obstruction detecting device 100, 300 determines a shorter distance between sensor 102 and a reflecting obstructing object than a distance calculated when no obstruction exists. In some embodiments, obstruction detecting device 100, 300 may have a calibration button (not shown), which when depressed when no obstruction exists, causes obstruction detecting device to calculate a threshold or default distance to a reflecting object for comparison with future calculated distances such that calculated distances shorter than the threshold or default distance may indicate a presence of an obstruction.

Although not shown, in some embodiments, sensor 102 may be connected with obstruction detecting device via a wireless connection. In such embodiments, sensor 102 may have a WiFi connection, a Bluetooth® (Bluetooth is a registered trademark of Bluetooth Sig, Inc., a Delaware Corporation) connection, or other type of wireless connection with obstruction detecting device 100, 300.

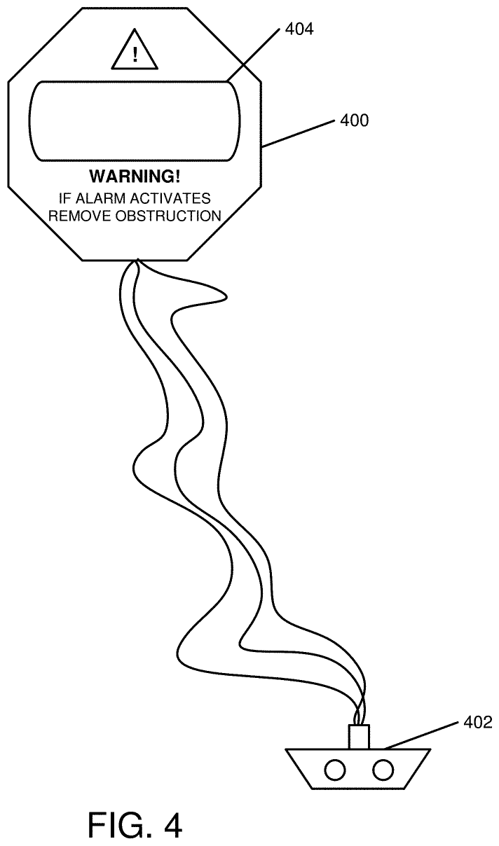

FIG. 4 illustrates another embodiment of obstruction detecting device 400. In this embodiment, obstruction detecting device 400 may have an octagonal shape and may include a bright light 404 on a face of object detecting device 400. A textual message also may appear on the face such as, for example, “Warning! If alarm activates remove obstruction.” In other embodiments, a different textual message may appear on the face. Sensor 402 may be connected to a microcontroller (e.g., an Arduino microcontroller) (not shown) within obstruction detecting device 400 via a plurality of wires. In some embodiments, the wires may be encased in a cable (not shown) between obstruction detecting device 400 and sensor 402.

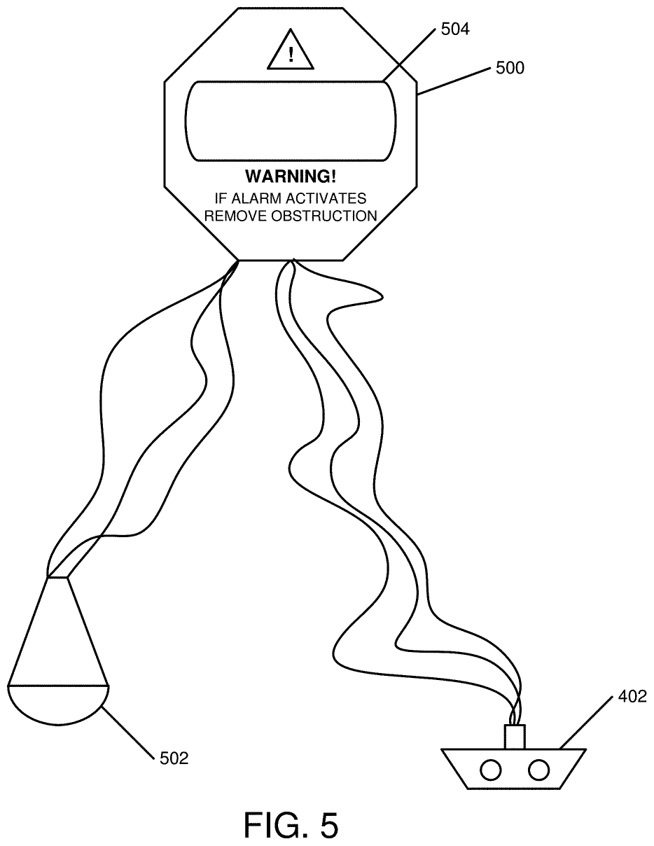

FIG. 5 illustrates another embodiment of obstruction detecting device 500, which includes a motion detector 502 (e.g., an infrared motion detector, which may be passive) connected via wires to a microcontroller included in obstruction detecting device 500. The distance sensor 402 (e.g., an ultrasonic or infrared distance sensor) may also be connected to the microcontroller via wires. In some embodiments, each set of wires may be encased in a cable or covering (not shown). In some embodiments, either or both sensor 402 and motion detector 502 may be wirelessly connected with obstruction detecting device 500 via WiFi, Bluetooth® or other type of wireless connection. In other embodiments, motion detector 502 may be mounted directly to a case of obstruction detecting device 500.

The motion detector 502 may detect motion of an object emitting heat. Operation of this embodiment which uses a passive infrared motion detector 502 will be discussed in a later portion of this specification.

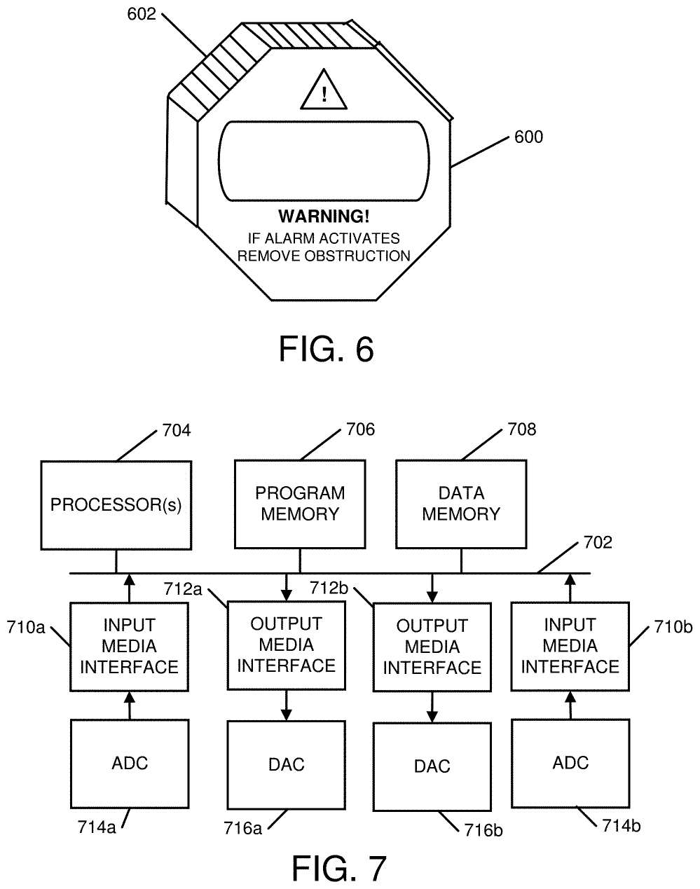

FIG. 6 illustrates a variation 600 of obstruction detecting device. In this variation, obstruction detecting device 600 may include solar panels 602 mounted on a top three surfaces of octagonal shaped obstruction detecting device 600. In this embodiment, lights in a proximity of obstruction detecting device 600 may provide power to a power source for the device 600, such as via solar panels 602, for charging a battery (not shown) included as parts of the power source for the obstruction detecting device 600.

FIG. 7 illustrates a functional block diagram of a microcontroller that may be included in various embodiments of the obstruction detecting device. The microcontroller may include a system bus 702. A number of components may be connected with system bus 702. The components may include one or more processors 704, a program memory 706, a data memory 708, input port media interfaces 710a, 710b, and output port media interfaces 712a, 712b.

Program memory 706 may include a non-volatile machine-readable storage medium such as, for example, flash memory, erasable programmable read-only memory (EPROM) and electrically erasable programmable read-only memory (EEPROM). Data memory may include a volatile machine-readable storage medium such as, for example, random access memory (RAM) or other volatile machine-readable storage medium.

Input/Output (I/O) peripherals interface one or more processors 704 of the microcontroller with other external components. For example, input port media interfaces 710a, 710b allow the microcontroller to receive input from the external components. Output port media interfaces 712a, 712b allow the microcontroller to provide output to the external components.

Analog-to-Digital-Converters (ADCs) 714a, 714b, connected to respective input media interfaces 710a, 710b, receive analog input from corresponding analog components such as, for example, a distance sensor and a motion detector, and convert the analog input to digital form, which is then provided to the corresponding input media interface 710a, 710b.

Digital-to-Analog Converters (DACs) 716a, 716b, connected to respective output media interfaces 712a, 712b, receive digital output from respective output media interfaces 712a, 712b and convert the digital output to analog form, which is then provided to corresponding external components such as, for example, an distance sensor, a motion detector, a notification device, such as a speaker and/or one or more lights, etc.

System bus 702 is a connective wire that connects together one or more processors 704, program memory 706, data memory, 708, input media interface 710a, 710b, and output media interface 712a, 712b.

Although FIG. 7 shows a microcontroller having two input media interfaces and two output media interfaces, the microcontroller may have more or fewer input media interfaces and output media interfaces in other embodiments.

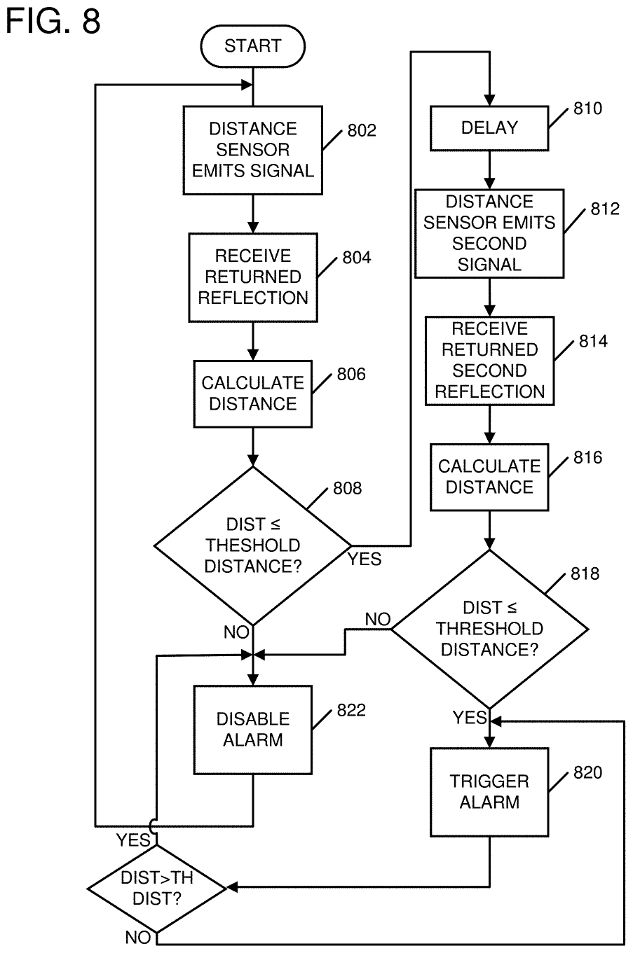

FIG. 8 is a flowchart that illustrates an example process for obstruction detecting device 100, 300, 400, 600 to determine whether access to a feature of a building is obstructed. The process may begin with one or more processors 704 of a microcontroller included in obstruction detecting device 100, 300, 400, 600 sending a signal to distance sensor 102, 402 to emit a signal or pulse (act 802). One or more processors 704 then waits and receives a return reflection (e.g., echo for an ultrasound sensor) of the signal pulse reflected from a reflecting object (act 804). One or more processors 704 then calculates a distance between distance sensor 102, 402 and the reflecting object based on an amount of time between emitting the signal and receiving the echo or reflection of the signal (act 806). In some embodiments, the distance may be calculated by dividing the amount of time by two and multiplying a result by a speed of sound.

(Time/2)×(Speed of Sound)=Distance

Next, one more processors 704 may determine whether the distance is less than or equal to a threshold or default distance (act 808). If the distance is not less than or equal to the threshold or default distance, then no obstruction was detected, an alarm may be disabled (act 822) and acts 802-808 may be performed again. Otherwise, if during act 808, the distance is determined to be less than or equal to the threshold distance, then an obstruction was detected. However, a determination may be made regarding whether the obstruction is only a momentary obstruction by delaying an amount of time such as, for example, 3 seconds or another suitable time period (act 810), sending a command to sensor 102, 402 to emit a second signal or pulse (act 812), receiving a second returned echo or reflection (act 814), calculating a distance between sensor 102, 402 and a reflecting object, and determining whether the calculated distance is less than or equal to the default or threshold distance (act 818).

If, during act 818, the calculated distance is determined to be less than or equal to the threshold or default distance, then an alarm may be triggered (act 820). Otherwise, if the calculated distance is determined not to be less than or equal to the threshold or default distance, then an alarm is disabled (act 822) and acts 802-808 may be performed again. The alarm may include sounding an audible alarm such as, for example, a beeping sound or a bell, and/or activating a visual signal such as a flashing of bright light 104, 402. In some embodiments, a number of beeps and a number of flashes of the bright light may indicate a cause of the triggering of the alarm such as, for example, a cutting or breaking of a wire connecting sensor 102, 402 with the microcontroller, an obstruction blocking access to a building feature, and expiration of a timer indicating a time for inspecting safety equipment.

In some embodiments, when the alarm is provided, the microcontroller may also or alternatively cause an alarm indication or signal to be transmitted to a remote computer for processing and/or display, such as on an online dashboard. The alarm indication may be wirelessly transmitted or transmitted via a wired connection.

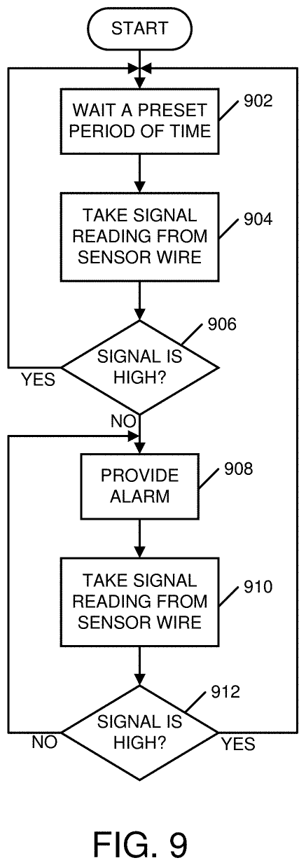

FIG. 9 is a flowchart of an example process for a microcontroller of obstruction detecting device 100, 300, 400, 600 to determine whether a signal wire between sensor 102, 402 is broken or cut. The process may began by waiting a preset period of time such as, for example, one minute or another suitable time period (act 902). After waiting, one or more processors 704 of the microcontroller may take a signal reading from the sensor wire (act 904). One or more processors 704 then may determine whether the read signal is high, indicating that the signal wire between the microcontroller and sensor 102, 402 is intact (act 906). If the signal is determined to be high, then acts 902-906 may be performed again. Otherwise, if, during act 906, the read signal is determined not to be high, thereby indicating a cut or broken sensor wire, then an alarm is provided (act 908). The alarm may include an audible alarm to provide beeps and/or the flashing of bright light 104, 404. The microcontroller then may take another signal reading from the sensor wire (act 910) and determine whether the read signal is high (act 912). If the signal is high, then acts 902-906 again may be performed. Otherwise, act 908 again may provide an alarm and acts 910-912 may be performed.

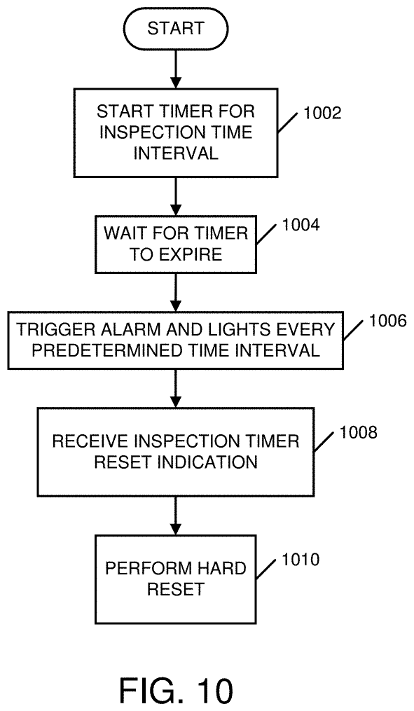

FIG. 10 is a flowchart illustrating an example process for timing an inspection interval and triggering an alarm when a time has been reached to inspect safety equipment. The process may begin with one or more processors 704 of the microcontroller starting a timer for an inspection time interval (act 1002). For example, if a fire extinguisher located close to an obstruction detecting device should be inspected once every 30 days, then the timer may be started for a time interval of 30 days.

Next, one or more processors 704 may wait for the timer to expire (act 1004). After expiration of the timer, one or more processors 704 may trigger an alarm (act 1006). The alarm may include an audible alarm, which may provide a preset number of beeps, and/or a bright light, which may provide a preset number of flashes. One or more processors 704 may wait to receive an inspection timer reset indication, which may be provided after the emergency equipment is inspected (act 1008). The inspection timer reset indication may be provided as a result of a user using a reed switch and a magnetic fob, or via other means. Receipt of the inspection timer reset indication may cause the obstruction detecting device to perform a hard reset, similar to powering the device off and then on.

In another embodiment, obstruction detecting device 500 includes two sensors, both of which are connected to a microcontroller included in obstruction detecting device 500 via a wired or wireless connection. In some embodiments, an infrared motion detector 502 detects motion by detecting a moving object that generates heat such as, for example, a person. In various embodiments, the sensor 402 is an ultrasonic sensor 402 that emits an ultrasonic signal pulse and determines a distance to a reflecting object based on an amount of time for an echo of the ultrasonic signal pulse to be received by ultrasonic sensor 402.

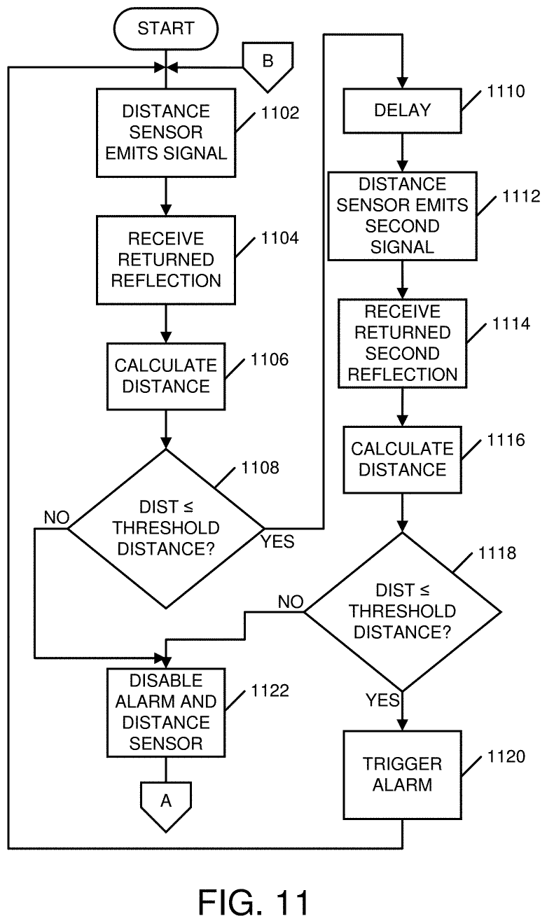

In some embodiments, obstruction detecting device 500 may be powered by an external power source, such as a wall outlet. In other embodiments, obstruction detecting device 500 may be powered by a power source that is internal, such as a battery. In such embodiments, preservation of electrical power increases longevity of the battery. FIG. 11 is a flowchart of an example process that may be performed by obstruction detecting device 500 to detect an object obstructing access to a safety feature while otherwise preserving battery power.

The process may begin with one or more processors of a microcontroller, included within obstruction detecting device 500, sending a command to sensor 402 to emit a signal or pulse (act 1102). Distance sensor 402 then receives a returned reflection of the signal reflected from a reflecting object (act 1104). One or more processors 704 of the microcontroller may calculate a distance between distance sensor 402 and the reflecting object based on an amount of time between emission of the signal and receiving of the reflection (e.g., echo) (act 1106). If the calculated distance is determined to be less than or equal to a minimum threshold distance (act 1108), then an object is determined to be obstructing access to the safety feature. However, the obstruction may be momentary. Therefore, one or more processors 704 may delay for a period of 3 seconds or another suitable time period (act 1110) before sending a command to distance sensor 402 to emit a second signal or pulse (act 1112). Distance sensor 402 may receive a second reflection of the signal or pulse reflected from a reflecting object and may provide an indication of the received reflected signal to one or more processors 704 (act 1114). One or more processes 704 then may calculate a distance between sensor 402 and the reflecting object based on an amount of time between emission of the second signal or pulse and receiving of the returned second reflection of the second signal or pulse (act 1116). If the calculated distance is determined to be less than or equal to the minimum or threshold distance (act 1118) then one or more processors 704 may trigger an alarm (act 1120) and acts 1102-1108 again may be performed. Triggering the alarm may include sounding an audible alarm, which may beep, and/or flashing a bright light 504. A number of beeps sounded and a number of times bright light 504 is flashed may be equal in some embodiments. Further, the number of beeps and flashes may indicate a cause of the alarm such as, for example, a cut or broken signal wire, obstructed access to a safety feature, and an inspection time for inspecting safety equipment such as, for example, a fire extinguisher or other safety equipment.

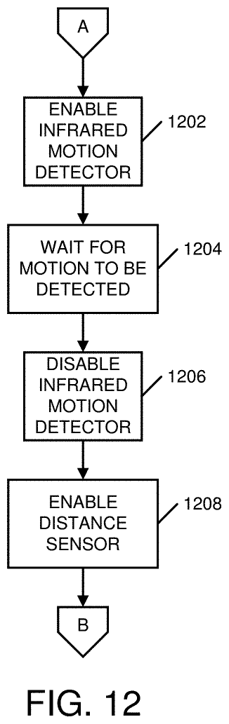

If, during act 1118 or during act 1108, the calculated distance is determined not to be less than or equal to the threshold distance, then the alarm and the distance sensor may be disabled (act 1122) (e.g., an audio signal and/or a light signal may be turned off) and an infrared motion detector 502 may be enabled for detecting movement of an object emitting heat (act 1202; FIG. 12). Some embodiments use a passive infrared motion detector 502 because it uses very little power, thereby increasing longevity of the power source, e.g., battery.

After enabling infrared motion detector 502, one or more processors 704 of the microcontroller may wait to receive a signal from infrared motion detector 502 indicating that motion has been detected (act 1204). The microcontroller then may disable infrared motion detector 502 (act 1206) and enable distance sensor 402 (act 1208). Control then may pass to act 1102 to emit another distance sensor pulse/signal.

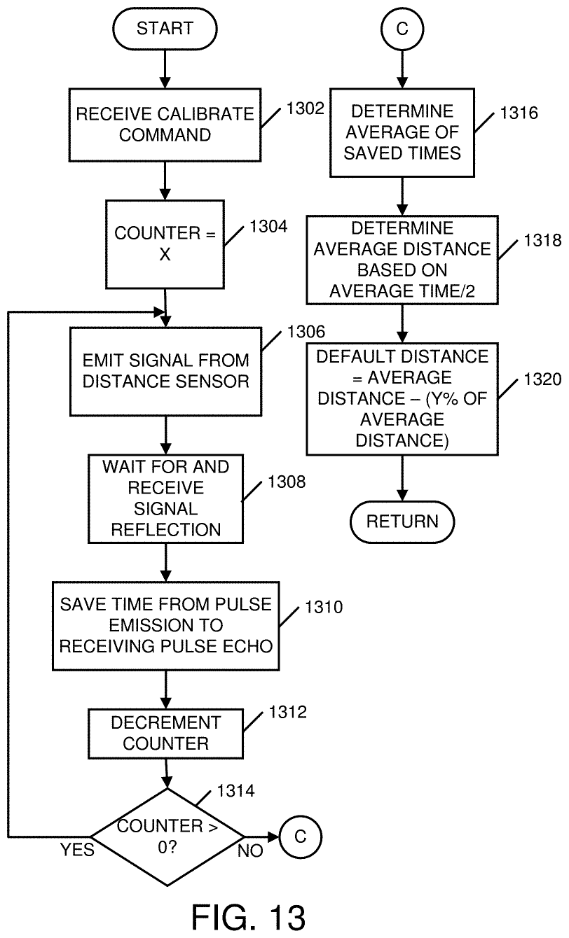

In some embodiments, obstruction detecting device may calibrate the threshold or default distance to which the calculated distance is compared in various embodiments. FIG. 13 is a flowchart illustrating an exemplary process that a microcontroller may perform in response to receiving a calibrate command. The calibrate command may be received in response to depressing a calibrate button or via other means in the various embodiments. In embodiments in which the calibrate command is received by the microcontroller in response to depressing the calibrate button, the calibrate button should only be depressed when the obstruction detecting device is in its operational position and no object is obstructing access to the safety feature.

The process may begin with one or more processors 704 of the microcontroller receiving the calibrate command (act 1302). One or more processors 704 may then set a counter to x, which may be number of signals or pulses sensor 102, 402 is to send (act 1304). X may be 5, 10, or another suitable integer value.

Next, one more processors 704 may send a command to distance sensor 102, 402 causing a signal or pulse to be sent (act 1306). One or more processors 704 then waits for and receives a reflection of the signal that is reflected from a reflecting object (act 1308). One or more processors determines an amount of time from a sending of the signal or pulse to receiving of a corresponding signal reflection and saves the amount of time in the data memory 708 (act 1310). Counter then may be decremented (act 1312) and a determination is made by one or more processors 704 regarding whether the counter has a value greater than zero (act 1314). If the counter is determined to have a value greater than zero, then acts 1306-1314 may be repeated.

Otherwise, if counter is determined to have a value that is not greater than zero, then one or more processors 704 may determine an average amount of time from the saved amounts of time (act 1316). An average distance may be calculated by one or more processors 704 based on the average time divided by two, which may then be multiplied by a speed of sound (act 1318). The threshold or default distance then may be set to a percentage of the calculated average distance subtracted from the calculated average distance (act 1320). In some embodiments, the percentage of the calculated average distance subtracted from the calculated average distance may be 10%. However, in other embodiments, the percentage may be 5%, 7%, or another suitable value.

In the embodiments discussed above, because obstruction of a safety feature is frequently checked, an alarm is provided within 3.5 minutes of when an object began obstructing access to a building feature (e.g., emergency equipment or an emergency exit). In many cases, the alarm is provided in much less time than 3.5 minutes after the obstruction began.

The foregoing description provides illustration and description, but is not intended to be exhaustive or to limit the possible implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations therefrom. For example, some components, described as being separate pieces or parts, may be integrated into one component. Similarly, one component may be divided into one or more sub-components, pieces, or parts. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used.

What is claimed is:

1. An obstruction detecting device for detecting an object that is obstructing access to a feature of a building, the obstruction detecting device comprising:
a microcontroller;
a distance sensor connected to the microcontroller; and
a notification device connected with the microcontroller;
wherein the obstruction detecting device is configured to perform operations comprising:
emitting a signal via the distance sensor;
receiving, via the distance sensor, a reflection of the signal from an object;
determining, by the microcontroller, a distance from the distance sensor to the object that caused the reflection based on an amount of time between the emitting of the signal and the receiving of the reflection of the signal; and
providing an alarm via the notification device when the determined distance is less than a threshold distance, indicating that the reflecting object is obstructing access to the feature.

2. The obstruction detecting device of claim 1, wherein the notification device includes a light; and
wherein providing the alarm comprises turning on the light.

3. The obstruction detecting device of claim 8, wherein the notification device includes a speaker; and
wherein providing the alarm comprises sounding an audio alarm using the speaker.

4. The obstruction detecting device of claim 1, wherein the obstruction detecting device further comprises a timer; and
wherein the operations further comprise:
starting the timer for a time interval for inspecting the feature of the building; and
providing a second alarm upon expiration of the timer to indicate that inspection is needed.

5. The obstruction detecting device of claim 4, wherein the providing of the second alarm comprises sounding a beep a preset number of times and blinking a light the preset number of times, the preset number of times indicating that a time is reached for inspecting the feature.

6. The obstruction detecting device of claim 1, wherein the operations further comprise:
reading a signal from a wire connected to the distance sensor;
responsive to the reading of the signal indicating a cut in the wire, triggering an alarm.

7. The obstruction detecting device of claim 1, wherein the obstruction detecting device further comprises a motion detector; and
wherein the operations further comprise:
disabling the distance sensor upon determining that the access to the feature of the building is clear;
detecting, using the motion detector and while the distance sensor is disabled, motion in an area covered by the motion sensor;
performing, upon detecting the motion:
enabling the distance sensor,
emitting a second signal via the distance sensor,
receiving, via the distance sensor, a second reflection of the second signal from a second object,
determining, by the microcontroller, a second distance from the distance sensor to the second object based on an amount of time between the emitting of the second signal and the receiving of the reflection of the second signal; and
providing the alarm when the determined distance is less than the threshold distance.

8. The obstruction detecting device of claim 1 further comprising:
a power source that is operably connected to the microcontroller, the distance sensor, and the notification device.

9. The obstruction detecting device of claim 1, wherein the notification device comprises a communication interface connected to the microcontroller; and
wherein the operations further comprise:
providing the alarm by transmitting the alarm via the communication interface, the alarm indicating that the reflecting object is obstructing access to the feature.

10. The obstruction detecting device of claim 1, wherein providing the alarm is delayed up to 3.5 minutes after the object began obstructing the access to the feature.

11. A method for detecting an object obstructing access to a feature of a building, the method comprising:
emitting a signal via a distance sensor connected with a microcontroller of an obstruction detecting device;
receiving, via the distance sensor, a reflection of the signal from an object;
determining, by a microcontroller of the obstruction detecting device connected to the distance sensor, a distance from the distance sensor to the object that caused the reflection based on an amount of time between the emitting of the signal and the receiving of the reflection of the signal; and
providing, by a notification device, an alarm when the determined distance is less than a threshold distance, indicating that the reflecting object is obstructing access to the feature.

12. The method of claim 11, wherein the sensor includes an ultrasonic sensor.

13. The method of claim, 11, wherein the providing of the alarm comprises sounding an audio alarm and turning on a light.

14. The method of claim 11, wherein the obstruction detecting device comprises a timer;
wherein the method further comprises:
starting the timer for a time interval for inspecting the feature of the building; and
providing a second alarm upon expiration of the timer to indicate that inspection is needed.

15. The method of claim 11, wherein the obstruction detecting device comprises a motion detector;
wherein the method further comprises:
disabling the distance sensor upon determining that the access to the feature of the building is clear;
detecting, using the motion detector of the obstruction detecting device and while the distance sensor is disabled, motion in an area covered by the motion detector;
performing, upon the detecting of the motion:
enabling the distance sensor,
emitting a second signal via the distance sensor,
receiving, via the distance sensor, a second reflection of the second signal from a second object,
determining, by the microcontroller, a second distance from the distance sensor to the second object based on an amount of time between the emitting of the second signal and the receiving of the reflection of the second signal, and
providing the alarm when the determined distance is less than the threshold distance.

16. The method of claim 11, wherein the notification device includes a communication interface operably connected to the microcontroller;
wherein the method further comprises:
providing the alarm by transmitting the alarm via the communication interface to an online dashboard when the determined distance is less than the threshold distance.

17. A non-transitory machine-readable storage medium having instructions recorded thereon for configuring a processor to perform operations comprising:
emitting a signal via a distance sensor connected to the processor;
receiving, via the distance sensor, a returned reflection of the signal from an object;
determining, by the processor, a distance from the distance sensor to the object that caused the reflection based on an amount of time between the emitting of the signal and the receiving of the reflection of the signal; and
providing, by the processor, an alarm when the determined distance is less than a threshold distance, indicating that the reflecting object is obstructing access to a feature of the building.

18. The non-transitory machine readable storage medium of claim 17, wherein the notification device includes a light; and
wherein providing the alarm comprises turning on a light.

19. The non-transitory machine-readable medium of claim 17, wherein the operations further comprise:
starting a timer for a time interval for inspecting the feature of the building; and
providing a second alarm upon expiration of the timer to indicate that inspection is needed.

20. The non-transitory machine readable storage medium of claim 17, wherein the operations further comprise:
disabling the distance sensor upon determining that the access to the feature of the building is clear;
detecting, using a motion detector and while the distance sensor is disabled, motion in an area covered by the motion sensor;
performing, upon the detecting of the motion:
enabling the distance sensor,
emitting a second signal via the distance sensor,
receiving, via the distance sensor, a second reflection of the second signal from a second object,
determining a second distance from the distance sensor to the second object based on an amount of time between the emitting of the second signal and the receiving of the reflection of the second signal; and
providing the alarm when the determined distance is less than the threshold distance.
